(19) United States
(12) Patent Application Publication
(10) Pub. No.: US 2012/0078912 A1
(43) Pub. Date: Mar. 29, 2012

(54) METHOD AND SYSTEM FOR EVENT CORRELATION

(76) Inventors: Chetan Kumar GUPTA, Austin, TX (US); Song WANG, Austin, TX (US); Abhay MEHTA, Austin, TX (US); Stefan BERGSTEIN, Ehningen (DE)

(21) Appl. No.: 12/888,626

(22) Filed: Sep. 23, 2010

(51) Int. Cl. G06F 17/30

(52) U.S. Cl. 707/740; 707/E17.089

(57) ABSTRACT

A method for event correlation includes receiving events from a network of systems and classifying the events into itemsets, where each itemset includes a set of frequently correlated events. The method also includes calculating a confidence value for each of the itemsets, identifying itemsets whose confidence values conform to a confidence criterion, and varying the confidence criterion to reduce the number of the identified itemsets. A computer program product and data processing system are also disclosed.

### FIELD OF THE INVENTION

The present invention relates to event correlation. More particularly, the present invention relates to event correlation in a collection or network of systems.

### BACKGROUND

Information technology (IT) management may be a complex and labor intensive process. The IT infrastructure of even a typical enterprise may include hundreds of networked systems running thousands of heterogeneous software applications. Each individual component of such systems may be configured to report exceptional conditions as they are detected. These conditions may be reported as human-readable events. Such an enterprise may generate tens of events per second. Typically, an operations management (OM) system streams these events to a network operations center (NOC). At the NOC, operators may process these events with the aim of restoring or maintaining smooth operation of the systems.

In some cases, a problem in one component may result in a related problem in another component. Thus, a single problem may lead to several reported events. For example, an error in reading a disk may be reported as an event by a subsystem that interfaces directly with the disk, as well as by subsystems that utilize data stored on the disk. An NOC operator may have difficulty dealing with a large number of events. Also, an operator monitoring one subsystem may not be aware of related events reported by other subsystems, whereas the significance of a reported event may depend on its context in light of other events.

### BRIEF DESCRIPTION OF THE DRAWINGS

Reference is made to the accompanying drawings, in which:

FIG. 1 shows schematically a network of systems capable of correlating reported events, in accordance with embodiments of the present invention;

FIG. 2 is a flowchart of a method for event correlation, in accordance with embodiments of the present invention;

FIG. 3 is a flowchart of an alternative method for event correlation, in accordance with some embodiments of the present invention; and

FIG. 4 is a flowchart of online on-demand analysis in accordance with embodiments of the present invention.

### DETAILED DESCRIPTION

In accordance with embodiments of the present invention, an OM system may receive reported events from a network of systems. The OM system may apply various statistical techniques known in the art to find correlations among the reported events. The OM system may initially classify frequently correlated events into sets of correlated events. The OM system then may process the sets of correlated events with the goal of selecting or generating from the initial event sets a smaller number of more meaningful sets of events.

Each of the sets of correlated events may be evaluated in light of confidence criteria. A confidence value or measure calculated for each correlated event set may indicate which sets are more likely to be related due to a common cause, and not just by coincidence. Comparison of the confidence value with the confidence criteria may identify high-confidence sets whose member events are most likely to be related by a common cause.

Further processing may evaluate or manipulate the sets with the goal of achieving a substantially minimal number of meaningful correlated event sets. As part of this processing, the sets may be evaluated with respect to various confidence criteria. The evaluation may identify confidence criteria that enable compressing the original set of correlated event sets to a substantially minimum number of high-confidence sets. At least some of these high-confidence sets may be meaningful. A high-confidence set may be considered meaningful when examination of the set assists an OM system operator in identifying an underlying problem or cause. Thus, the set of events is essentially replaced by a single representative event.

Determining meaningful correlations among reported events may reduce the amount of information presented to an OM operator. The reduced amount of information may enhance the OM operator's ability to notice connections among various reported events.

Typically, the OM system may initially detect correlations via statistical analysis of events. Correlations may be detected when a set of events frequently occur together. Statistical analysis may avoid limitations of techniques that detect correlations base on prior knowledge of system operation or architecture.

For example, the OM system may typically apply a data mining technique to determine which events occur within a predetermined time period. The further processing may eliminate from further consideration correlation of events that occur concurrently without any actual causal relationship.

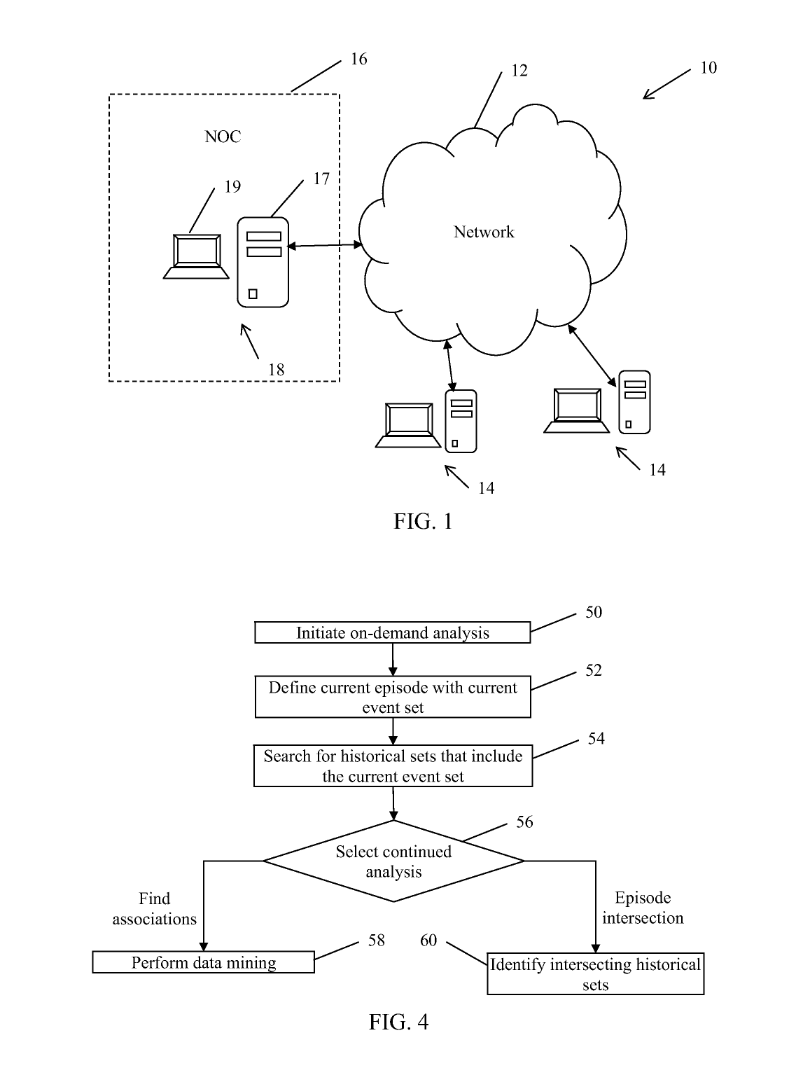

FIG. 1 shows schematically a network of systems capable of correlating reported events, in accordance with embodiments of the present invention. Networked system 10 includes a network 12. For example, network 12 may include a wired or wireless network, and may include an intranet, the Internet, or a mobile or stationary telephone network. Member subsystems 14 of networked system 10 may communicate with one another via network 12. A member subsystem 14 may include a processor, such as a computer, that includes an interface to network 12. A processor of a member subsystem 14 may generate an event message, hereinafter referred to as an event, when an exceptional condition occurs.

A generated event may be transmitted via network 12 to network operations center (NOC) 16. NOC 16 may include an operator station 18, which may include a processor 17 and input/output devices 19. The processor may be configured to run an operations management (OM) system application. An event generated by a member subsystem 14 may be forwarded via network 12 to operator station 18. For example, the generated event may include a character string containing an interpretable description or code, or other signal interpretable as an event.

A representation of an event may be output by an output device of operator station 18 in human understandable form (e.g. as a displayed, printed, or audible message or symbol, or as a visible or audible indicator).

A human network operator may monitor an output device of operator station 18. Such an operator may then analyze a displayed event. Analysis of one or more events may enable an operator to determine a cause of such event. For example, the cause may be a failure or problem that requires operator intervention to correct. When operator intervention is required, the operator may operate an output device of input/output devices 19 of operator station 18, such as a keyboard, pointing device, or switch.

An OM system running on a processor associated with operator station 18 may be configured to perform event correlation in accordance with embodiments of the present invention. When performing event correlation, an operator monitoring operator station 18 may view representations of events arranged in a manner that represents a compressed group of correlated event sets. For example, a correlated event set may be displayed as a list or other graphic arrangement of event messages, codes, or symbols.

One or more of the correlated event sets may represent events that are related to a common cause. A suitably trained operator may identify the cause upon examining one or more of the sets.

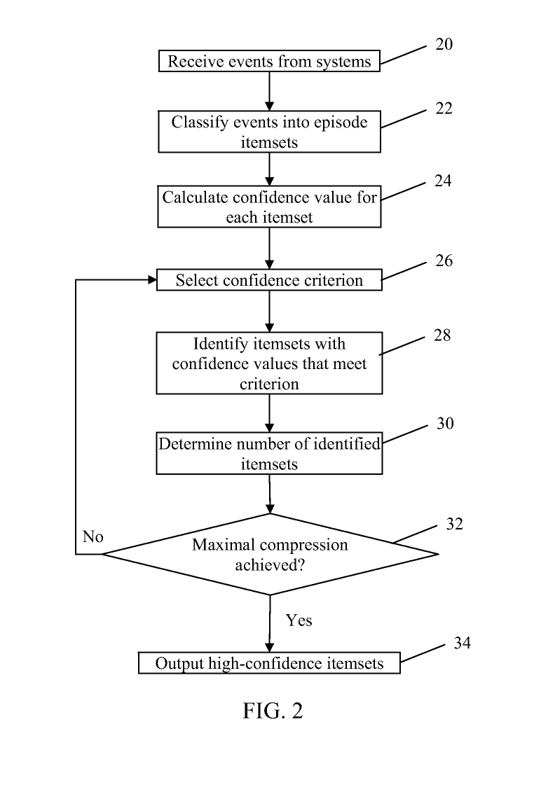

FIG. 2 is a flowchart of a method for event correlation, in accordance with embodiments of the present invention. It should be understood that in this flowchart, and in all flowcharts accompanying this description, division of actions associated with a method into discrete steps is for illustrative purposes only. Alternative division of the actions into steps may be possible with equivalent results, and all such alternative divisions should be considered to be within the scope of the current invention. Similarly, the order of steps in the flowchart is illustrative only, and should not be understood as demanding that actions be performed in a particular order. Alternative ordering of steps of the illustrated method may be possible. For example, steps may be performed in a different order, or concurrently, with equivalent results. All such alternative ordering of steps should be considered to be within the scope of the current invention.

An OM system may receive events from various member systems of a networked system (step 20). The OM system may maintain a database containing records of reported events.

Either upon a request by an operator, or under predetermined conditions, the OM system may perform event correlation. Event correlation, for example, may include classifying into a single set different events that often occur together within a defined time period, or window (step 22). Time windows may be defined such that there is some overlap between adjacent time windows. Such a time window may be referred to as an episode. The set of events that occur during the episode may be referred to as an itemset.

A preliminary operation may be performed on the itemsets associated with the episodes. A purpose of the preliminary operation may be to eliminate sets that are likely to represent itemsets that represent events that occurred together randomly or by chance, without being related to a common cause. For example, a rarely occurring itemset may represent a group of events that randomly occurred together during the episode. On the other hand, a frequently occurring itemset may represent events that are related to a common cause, and thus occur together.

For example, the OM system may include application of techniques of association rule mining (e.g. the Apriori association rule mining algorithm) in order to obtain sets of frequently correlated events. A frequency value, or support value, may be defined for each itemset. The support value of an itemset may be defined as the percentage or fraction of episodes containing that itemset. A threshold support value may be defined such that only an itemset that occurs more frequently than indicated by the threshold support value is selected for further consideration. A typical threshold support value is about 2%.

Events may be correlated on the basis of their being included in a single episode. The order of the events need not be taken into account. In a typical networked system, the order of events may not accurately represent operation of the system. For example, in a typical network of subsystems, the order of events received may depend on properties of the network connections, routing through the network, and the properties (such as memory, processor speed, or workload) of the particular subsystem that generated each event.

The OM system then may apply further refinement techniques in order to prune or limit the itemsets to those that may be meaningful in managing the system. A confidence value may be calculated for each itemset (step 24). The confidence value may indicate the likelihood that the events in the itemset are related to a common cause, and not simply by chance.

For example, calculation of the confidence value for an itemset may include calculation of the h-confidence, calculated in accordance with methods known in the art. The h-confidence of for an itemset {e₁, e₂, . . . , eₙ} of events e₁-eₙ may be defined as

$$h - confidence ( \{ {e}_{1} , {e}_{2} , … , {e}_{n} \} ) = \frac{\vert {e}_{1} ⋂ {e}_{2} ⋂ … ⋂ {e}_{n} \vert}{max \{ \vert {e}_{1} \vert , \vert {e}_{2} \vert , … , \vert {e}_{n} \vert \}} ,$$

where |e₁∩e₂∩ . . . ∩eₙ| represents the number of times that events {e₁, e₂, . . . , eₙ} of an itemset occur together (related to a support value for the itemset), and max {|e₁|,|e₂|, . . . , |eₙ|} represents the number of times that the most common event of the itemset occurs (related to the maximum support value for individual event). Thus, for example, an infrequently occurring set of events (small numerator) may have a low h-confidence. Similarly, when a single event of the itemset occurs very frequently (large denominator), the h-confidence is low. In this case, a low h-confidence level may indicate that an itemset occurs due to one or more ubiquitous member events, with many chance pairings.

A confidence criterion for the confidence value may be selected (step 26). Correlated events of a correlated event set whose confidence value conforms to the confidence criterion may have a greater likelihood of being related to a common cause than correlated events of a set that does not. Itemsets that conform to the confidence criterion are then identified (step 28). The number of identified itemsets that conform to the confidence criterion is then determined (step 30).

For example, when the confidence value includes an h-confidence, a threshold h-confidence level may be selected as the criterion. Itemsets whose h-confidence values meet or exceed the threshold h-confidence level may then be identified.

As stated above, a goal of event correlation in accordance with embodiments of the present invention is to display or otherwise present the identified itemsets for review by a human operator. Therefore, a goal of event correlation may be to select for presentation those itemsets that are likely to be meaningful to the operator. A typical operator may be more capable of advantageously reviewing a smaller number of presented itemsets than a larger number of itemsets. Therefore, event correlation may include performing an operation to reduce, or compress, the number of presented sets. A goal of the compression operation may be to achieve a substantially minimal number of meaningful sets of correlated events for presentation to the operator.

Typically, event correlation in accordance with embodiments of the present invention may include varying the confidence criterion to achieve an optimum compression. A compression may be defined as the ratio of the reduction in elements to an original number of elements. To take a simple example, if three events are replaced by a single itemset, the compression may be defined as

$$\frac{3 - 1}{3} ,$$

or ⅔ (The compression value may be typically expressed as a percentage, e.g. 66.7%.) An optimum compression is obtained when the number of itemsets cannot be further reduced. Thus, if the optimum compression has not yet been identified (step 32), a new confidence criterion may be selected (returning to step 26), and the process repeated (steps 28-30).

For example, varying the confidence criterion may include systematically incrementing the confidence criterion over a predetermined range of values. For each value of the confidence criterion, the number of itemsets conforming to the criterion is determined. In this manner, the confidence criterion yielding the smallest number of identified datasets may be selected. For example, a threshold value for an h-confidence may be varied until the number of sets whose h-confidence values exceed the threshold is substantially minimized.

Alternatively, or in addition, varying the confidence criterion may include application of an iteration technique. For example, the compression yielded by one or more previously selected confidence criteria may be utilized in selecting a new confidence criterion. This process may be repeated until convergence on an optimal compression is achieved.

When optimal compression is achieved (step 32), the identified itemsets may be output to an output device (step 34). For example, a set of events associated with each identified itemset may be displayed or printed such that an operator may review the sets.

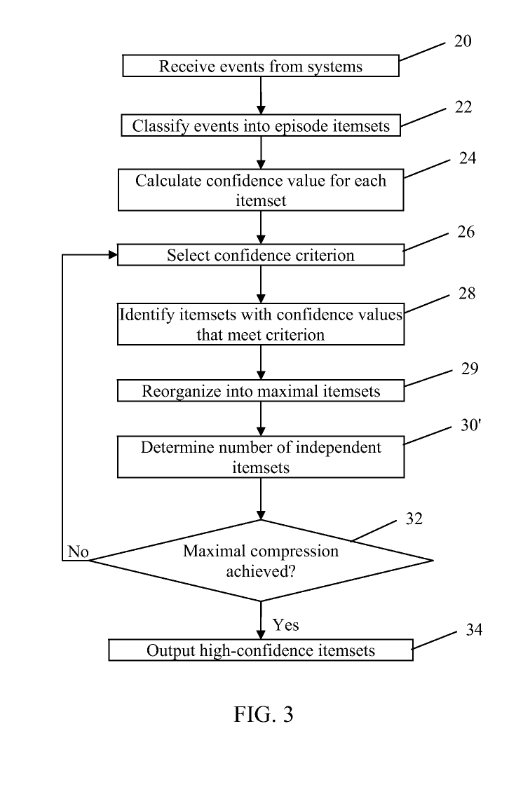

Event correlation in accordance with some embodiments of the present invention may include application of further techniques in order to achieve optimal compression and meaningfulness of correlated sets of events. FIG. 3 is a flowchart of an alternative method for event correlation, in accordance with some embodiments of the present invention. As in the method described above, received events (step 20) are organized or classified into itemsets (step 22) and a confidence value is calculated for each itemset (step 24). A confidence criterion is selected (step 26), and itemsets conforming to the selected confidence criterion are identified (step 28).

The number of itemsets may be reduced by combining two or more of the identified itemsets to form one or more maximal itemsets (step 29). For example, one identified itemset may include another identified itemset as a subset. In this case, the identified itemsets may be combined into a single larger itemset. The resulting maximal itemsets may thus be independent of one another in that no maximal itemset includes an event that is included in another. However, all of the resulting maximal itemsets may not be independent of one another. The number of the independent itemsets from among the maximal itemsets may then be determined (e.g. by counting independent itemsets) (step 30′). If the resulting independent itemsets do not represent maximal compression (step 32), a new confidence criterion is selected (returning to step 26) (e.g., increasing the value of h-confidence) and the process is repeated (steps 28-30′). The group of independent itemsets representing optimal compression is then output (step 34).

Methods as described above may be suitable for offline event analysis. In offline event analysis, the above methods may be performed under predetermined conditions. For example, offline event analysis may be performed at predetermined times or dates, or when system activity drops below a predetermined level. Alternatively or in addition, offline event analysis may be initiated by an operator at the operator's discretion.

In addition, online on-demand event analysis may be performed when required. For example, an OM system operator attempting to diagnose a situation may input a command to commence on-demand analysis.

In on-demand analysis, an operator initially identifies a current episode and identifies events associated with the episode. The identified events define a current set of events associated with the current episode. For example, the current set of events may be related to a current problem that the operator wishes to diagnose. An OM system that implements an on-demand analysis application then receives the operator-defined current set of events.

On-demand analysis then enables the operator to identify other past episodes, or other sets of events, that include the current set of events. Typically, on-demand analysis is configured to rapidly identify such episodes. Identifying such past episodes may aid in understanding the current episode. For example, a past episode may include other events in addition to the current set of events. The operator may then search for such other events in the current episode. Identification of such other events in the current episode may suggest a similarity between the current episode and that past episode. Identification of such other events may also enable the operator to modify or refine the definition of the current episode. The on-demand analysis may then be repeated with the refined definition of the current episode.

FIG. 4 is a flowchart of online on-demand analysis in accordance with embodiments of the present invention. When initiating on-demand analysis (step 50), an operator identifies a current set of events associated with a current episode (step 52). For example, the operator may designate a period of time as an episode, such that all events during that period of time are considered to be associated with the episode. Alternatively or in addition, the operator may designate specific events as selected or excluded. For example, an experienced operator may recognize that an event is unrelated to other events occurring during the episode, or may select a relatively small number of most significant events.

Once a current set of events is defined, a database or other repository of historical data may be searched for sets of data that include the current set of events (step 54). For example, the historical data may include sets of events each associated with an episode. As another example, the historical data may include itemsets created during offline analysis.

For example, on-demand analysis may include application of a Bloom filter technique, as known in the art, to determine which of the historical event sets contain the current event set as a subset. A Bloom filter represents a space-efficient probabilistic data structure that may be used to test whether an element is a member of a set. Typically, application of a Bloom filter technique quickly yields approximate results in a space efficient manner. Use of indexed Bloom filters, as are known in the art, may further expedite the technique. Results of application of the Bloom filter technique may be approximate in that falsely positive results are possible, but not falsely negative. In other words, application of a Bloom filter technique may occasionally mistakenly identify a historical event set as including the current event set. However, every historical event set that includes the current event set may be identified.

Upon identification of historical event sets that include the current event set as a subset, on-demand analysis may continue in one or more of several possible directions (step 56). For example, a direction for continued on-demand analysis may be selected by an OM system operator in accordance with a current need. Alternatively, an OM system that implements on-demand analysis may be configured to automatically select a direction for continued analysis in accordance with pre-determined criteria.

One analysis direction may include finding associations among the event sets. Finding associations may include performing data mining among the identified historical sets (step 58). For example, the data mining operation may include application of association rule mining to the identified historical sets. The result of the data mining operation may include identification of sets of strongly correlated events.

Another analysis direction may include identifying intersections among the identified sets of historical events (step 60). Identifying associations may provide an alternative method of determining correlations among the identified sets of historical events. Typically, finding intersections among the identified sets requires less time and fewer computational resources than finding associations via data mining. However, the results of identifying intersections may be less accurate or complete than the results of finding associations.

In identifying intersections among the identified sets of historical events, sets of events that are common to groups of the identified sets may be identified. Typically, an intersection is identified as such only if the number of events in common is at least a predetermined threshold value (typically 3). Identification of intersections may include a second or further iteration of identifying intersections. For example, intersections may be found among intersections that were identified in a previous iteration. The sets of events resulting from the intersection operations may be displayed or otherwise presented for review by an OM system operator or other user.

An operator may then examine the results of the on-demand analysis. For example, the operator may examine identified historical event sets, strongly correlated event sets, or event sets representing intersections of the identified sets. Examination may assist the operator in defining or diagnosing a situation. For example, examination of the results may indicate that in a certain historical event set, the current event set was accompanied by other events. A search for the other events in connection with the current event set may enable the operator to determine whether or not the cause of the current event set is similar to that of the historical event set.

Event correlation, according to embodiments of the present invention, may be implemented in the form of software, hardware or a combination thereof.

Aspects of the present invention, as may be appreciated by a person skilled in the art, may be embodied in the form of a system, a method or a computer program product. Similarly, aspects of the present invention may be embodied as hardware, software or a combination of both. Aspects of the present invention may be embodied as a computer program product saved on one or more computer readable medium (or mediums) in the form of computer readable program code embodied thereon.

For example, the computer readable medium may be a computer readable signal medium or a computer readable storage medium. A computer readable storage medium may be, for example, an electronic, optical, magnetic, electromagnetic, infrared, or semiconductor system, apparatus, or device, or any combination thereof.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer program code in embodiments of the present invention may be written in any suitable programming language. The program code may execute on a single computer, or on a plurality of computers. The computer may include a processing unit in communication with a computer usable medium, wherein the computer usable medium contains a set of instructions, and wherein the processing unit is designed to carry out the set of instructions.

Aspects of the present invention are described hereinabove with reference to flowcharts and/or block diagrams depicting methods, systems and computer program products according to embodiments of the invention.

What is claimed is:

1. A method for event correlation, the method comprising:
receiving events from a network of systems;
classifying the events into itemsets, each itemset including a set of frequently correlated events;
calculating a confidence value for each of the itemsets;
identifying those itemsets whose confidence values conform to a confidence criterion; and
varying the confidence criterion to reduce the number of the identified itemsets.

2. The method as claimed in claim 1, wherein classifying the events comprises data rule mining.

3. The method as claimed in claim 1 wherein the confidence value comprises h-confidence and wherein conforming to a confidence criterion comprises h-confidence being equal to or greater than an h-confidence threshold.

4. The method as claimed in claim 1, comprising combining two or more of the identified itemsets into a single set.

5. The method as claimed in claim 1, wherein the number of identified itemsets is the number of independent identified itemsets.

6. The method as claimed in claim 1, comprising receiving a current set of events, and finding those itemsets that include the current set of events as a subset.

7. The method as claimed in claim 6, comprising identifying intersections among those found itemsets that include the current set of events as a subset.

8. The method as claimed in claim 6, wherein finding itemsets comprises applying a Bloom filter.

9. The method as claimed in claim 1, wherein varying the confidence criterion comprises varying the confidence criterion to reduce the number of the identified itemsets to a substantial minimum.

10. A computer program product for event correlation, the computer program product being stored on a non-transitory tangible computer readable storage medium, the computer program including code for:
receiving events from a network of systems;
classifying the events into itemsets, each itemset including a set of frequently correlated events;
calculating a confidence value for each of the itemsets;
identifying those itemsets whose confidence values conform to a confidence criterion; and
varying the confidence criterion to reduce the number of the identified itemsets.

11. The computer program product as claimed in claim 10, wherein classifying the events comprises data rule mining.

12. The computer program product as claimed in claim 10, wherein the confidence value comprises h-confidence and wherein conforming to a confidence criterion comprises h-confidence being equal to or greater than an h-confidence threshold.

13. The computer program product as claimed in claim 10, comprising code for combining two or more of the identified itemsets into a single set.

14. The computer program product as claimed in claim 10, wherein the number of identified itemsets is the number of independent identified itemsets.

15. The computer program product as claimed in claim 10, comprising receiving a current set of events, and finding those itemsets that include the current set of events as a subset.

16. The computer program product as claimed in claim 15, comprising identifying intersections among those found itemsets that include the current set of events as a subset.

17. The computer program product as claimed in claim 15, wherein finding itemsets comprises applying a Bloom filter.

18. The computer program product as claimed in claim 10, wherein varying the confidence criterion comprises varying the confidence criterion to reduce the number of the identified itemsets to a substantial minimum.

19. A data processing system for event correlation for operation management, the system comprising:
a processing unit in communication with a computer usable medium, wherein the computer usable medium contains a set of instructions wherein the processing unit is designed to carry out the set of instructions to:
receive events from a network of systems;
classify the events into itemsets, each itemset including a set of frequently correlated events;
calculate a confidence value for each of the itemsets;
identify those itemsets whose confidence values conform to a confidence criterion; and
vary the confidence criterion to reduce the number of the identified itemsets.

20. The data processing system as claimed in claim 19, wherein the instruction to vary the confidence criterion comprises varying the confidence criterion to reduce the number of the identified itemsets to a substantial minimum.
